(19) United States
(12) Patent Application Publication
(10) Pub. No.: US 2018/0220638 A1
(43) Pub. Date: Aug. 9, 2018

(54) AGRICULTURAL APPLICATOR WITH AUTOMATIC CONTROL OF THE DAMPENING OF THE APPLICATOR BOOM

(71) Applicant: Deere & Company, Moline, IL (US)

(72) Inventors: VALENTIN GRESCH, Kaiserslautern (DE); FREDERIC BALLAIRE, Neustadt Weinstrasse (DE); WILLY PEETERS, Overloon (NL); MARCO DRIEST, Ames, IA (US); MARTIN KREMMER, Bettendorf, IA (US); DIRK ALDERS, Overloom (NL)

(21) Appl. No.: 15/890,811

(22) Filed: Feb. 7, 2018

(30) Foreign Application Priority Data
Feb. 7, 2017 (DE) 102017201918.2

(51) Int. Cl. A01M 7/00; B05B 1/20

(52) U.S. Cl. CPC A01M 7/0057; B05B 1/205; A01M 7/0075; A01M 7/0089

(57) ABSTRACT

An agricultural applicator includes a chassis supported on a ground surface and an applicator boom controllably movable with respect to the chassis about a pivot axis defined in a driving direction or suspended in a height-adjustable manner. An electronic control unit receives a sensor value regarding a current driving status of the chassis, and a dampening element is controlled by the electronic control unit based on the sensor value to dampen the movement of the applicator boom. The electronic control unit is programmed to calculate an expected driving status of the applicator based on the sensor value and variable physical parameters of the applicator, and to output a control signal to the dampening element based on an expected driving status of the applicator. The electronic control unit operably controls the dampening element to adjust dampening based upon a minimization of undesired movements of the applicator boom.

### RELATED APPLICATIONS

This application claims priority to German Patent Application Ser. No. 102017201918.2, filed Feb. 7, 2017, the disclosure of which is hereby expressly incorporated by reference in its entirety.

### FIELD OF THE DISCLOSURE

The present disclosure relates to an agricultural applicator with an applicator boom and a chassis supported on the ground, and in particular to an applicator boom movable with respect to a chassis about a pivot axis running in a driving direction or is suspended height-adjustably and has a width measured transverse to the driving direction that is a multiple of the transport width of the applicator, and further includes a dampening element for dampening the movement of the applicator boom, controllable by an electronic control unit, and supplied with a sensor value regarding the current driving status of the chassis and operated to change the dampening of the dampening element on the basis of the sensor value.

### BACKGROUND

Field sprayers are used to apply agricultural products onto a field. Field sprayers can be designed as self-propelled or towed vehicles or can be hitched to a towing vehicle (tractor). They include a relatively wide applicator boom, which can be folded up for transport and on which nozzles for application of the product are distributed over the width of the applicator boom. The products are usually liquids, which serve to fertilize plants planted on the field or to combat diseases or pests. As a rule, the product is intended to be applied in predetermined amounts per unit of area, which are constant or can vary over a field. In order to be able to apply the desired amount effectively it is important that an applicator boom carrying nozzles for product application be moved over the ground at a specific height. If the applicator boom is too high, the product will be distributed over too great an area and if it is too low the product will be released in an area that is too small. Usually the height and lateral tilt of the applicator boom can be varied and the tilt of the applicator boom is electronically controlled (see EP 2 591 657 A1), in order to guide it parallel to the ground at a desired height. Problems in maintaining the height result in particular when the ground is uneven or when the field sprayer travels around a curve since, because of the width of the applicator boom, movements (rolling movements) of the vehicle tilting to the side lead to quite large height movements and oscillations of the applicator boom, which cannot be regulated sufficiently rapidly in all cases.

The suspension of the applicator boom is usually equipped with springs and dampening elements. A suspension (spring-dampener system) with appropriate dampening properties is important for a stable applicator boom control and thus for the uniform application of products. The design of the suspension system is thus an important job in the development of field sprayers. In a conventional applicator boom, suspensions typically have the properties of a second order low-pass filter. Models from various manufacturers or manufacturers series differ, for example, in the limit frequency of the suspension system. A low limit frequency produces a good dampening behavior for high-frequency excitations, but also has a poor response behavior (which is disadvantageous in many cases). A system with a high limit frequency offers a good response behavior, but has poor dampening in the case of high frequency excitations. The manufacturers of field sprayers optimize the response behavior of an applicator boom on the basis of experience, simulations, and tests. Such optimization in the prior art is always a compromise, so as to obtain a good response behavior and appropriate dampening of excitations.

Measures have also been proposed in conventional sprayers to improve the height control of the applicator boom of a field sprayer through a variable dampening of the rolling movement of the applicator boom. For instance, DE 10 2011 117 805 A1 describes a field sprayer with applicator boom halves hinged to a lift system, where the oscillating movement of the boom halves is reduced by spring dampeners with dampening that is adjustable and corresponds to the relevant use. DE 103 14 686 A1 proposes that the dampening of the applicator boom about the pivot axis be dependent on the height of the applicator boom.

DE 20 2013 011 983 U1 describes a field sprayer with an applicator boom, whose pendulum movement is dampened by adjustable dampeners on an electro- or magnetorheological basis, which is controlled in dependence on registered movements of the applicator boom.

According to EP 2 526 755 A1, the dampening of the applicator boom is dependent on the speed, steering angle, and fill level of the tank of the field sprayer. EP 2 526 756 A1 proposes to create the dampening in dependence on the topography of the field being traversed, which is determined by means of position data.

EP 2 559 332 1 proposes to create the dampening in dependence on the speed of rotation about the vertical axis in order to counteract possible centrifugal forces. If the field sprayer is traveling around a curve, centrifugal forces act on the center of gravity of the applicator boom, which, without countermeasures, lead to a deflection of the boom at the sprayer chassis due to the spring suspension of the applicator boom. The dampening of the suspension of the applicator boom is changed or the tilt of the boom is adjusted by means of an actuator as countermeasures to compensate said centrifugal forces.

In EP 2 829 177 A1, the dampening of the applicator boom is produced by hydraulic cylinders, which also serve to adjust the angle of the applicator boom about the vertical axis. The dampening is dependent on the acceleration of the vehicle and the slope of the terrain.

Accordingly, designing the dampening of the applicator boom to be variable with respect to the field sprayer chassis in order to reduce lateral rolling movements is known. The input quantities, however, can only provide a rough estimate of what dampening is in fact required to dampen the applicator boom effectively and, for this reason, leads to a non-optimal behavior of the applicator boom movement.

### SUMMARY

In this disclosure, an agricultural sprayer is equipped with an applicator boom and a chassis supported on the ground. The applicator boom can be moved with respect to the chassis about a pivot axis that runs in the driving direction or is suspended in a height-adjustable way. It has a width that is measured transverse to the driving direction and is a multiple of the transport width of the sprayer. A dampening element is provided to dampen the movement of the applicator boom, and can be controlled by an electronic control unit, which is provided with a sensor value with respect to the current driving status of the chassis and can be operated to change the dampening of the dampening element on the basis of the sensor value. The electronic control unit is programmed, by means of the sensor value and variable physical parameters of the applicator, to calculate predictively an expected driving status of the applicator and, by means of the expected driving status of the applicator, to output a control signal to the dampening element so as to adjust its dampening for purposes of minimizing undesired movements of the applicator boom.

In other words, it is known by means of the current driving status of the applicator and variable physical parameters of the applicator how the chassis or the applicator will move in the near future. For example, by means of the tire pressure, the spacing of the wheels (track width), and the rate of rotation of the chassis about the vertical axis one can know that and to what extent the applicator will tilt to the side when following a curve. This lateral tilt serves to set the dampening of the dampening element. A greater dampening can be set in particular when tracking of the applicator boom along the movement (tilt) of the chassis is desirable. With greater dampening the applicator boom becomes linked to the chassis more rigidly. However, the applicator boom should be linked less rigidly to the chassis in particular when traveling over potholes, in order to transfer the chassis movements to the applicator boom as little as possible. For the example of a curved path it is thus as a rule advantageous if the control device increases the dampening, since the applicator boom otherwise tilts significantly due to centrifugal forces. A linking to the tilt of the vehicle (due to increased dampening of the dampening element) is thus usually less disadvantageous than the movement of a relatively weakly dampened applicator boom that is induced by centrifugal forces. In the case of an uneven driving path the control device on the other hand will dampen the applicator boom only weakly. In this way an improved matching of the dampening to the relevant operating situation of the applicator is achieved.

The electronic control unit can be programmed to take into account the effect of the current, adjustable geometry of the applicator boom on the expected driving status of the applicator when generating the control signal. Thus, in certain field sprayers the two boom wings can be tilted upward up to 10°. For a conventional 36-meter-wide applicator boom this corresponds to a vertical lift of the tip of the applicator boom tip of nearly 3 meters. It is clear that the geometry of the applicator boom that can be changed in this way will also affect the driving properties of the applicator boom. In addition, the reader is referred to other adjustment possibilities of applicator booms. EP 2 186 405 A1 describes an applicator boom with a plurality of segments, which can be matched to the ground contour. The geometry of such an applicator boom can likewise be taken into account in the described way.

The sensor value regarding the current driving status of the applicator or the expected driving status of the applicator can concern the lateral tilt of the applicator, the tilt of the applicator in the forward direction, the acceleration of the applicator, the speed or acceleration of the chassis, the applicator in the forward direction and/or vertical direction (for purposes of deriving information about short-term vertical vehicle excitations caused by potholes, rocks, uneven terrain), the rate of rotation of the applicator about the vertical axis, lengthwise axis (rolling), the transverse axis (pitching), or a change of the orientation over time.

The sensor value regarding the current driving status of the applicator can also be derived from measured values of a vehicle suspension.

The physical parameters of the applicator can be its track width, the total weight of the applicator (which, for example, can be determined by means of a sensor integrated into the tires that measures the contact force of the wheels of the applicator or a sensor mounting between the chassis of the applicator and a wheel suspension), or the fill level of a tank, which can be detected directly (by means of a sensor) or indirectly (via the initial fill and withdrawn amount or by means of the reaction of the chassis to a steering movement or acceleration).

The electronic control unit can be programmed to take into account additional data concerning the topography of the terrain to be traversed in each case, in the calculation of the expected driving status of the applicator.

The electronic control unit can be programmed to calculate the expected driving status by means of a mathematical model representing the physical behavior of the applicator or the applicator boom.

The dampening element can be a hydraulic cylinder, which is additionally controlled by the control unit as an actuator to adjust the applicator boom about the pivot axis or for vertical adjustment in order to orient the applicator boom parallel to the ground or crop underneath it at a desired height about the ground or crop that is under it.

The hydraulic cylinder can, for purposes of achieving the adjustable dampening properties of the hydraulic cylinder, be connected to a pneumatic pressure tank via a valve with variable opening that is controlled by the control unit.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawing, wherein:

FIG. 1 shows a side view of an applicator designed as a self-propelled field sprayer,

FIG. 2 shows a rear view of the deployed applicator boom of the applicator of FIG. 1,

FIG. 3 shows an enlarged rear view of the middle part of the applicator boom of FIG. 2,

FIG. 4 shows a schematic of a sensor for registration of the current driving status of the chassis of the applicator,

FIG. 5 shows a schematic of the hydraulics for lift control of the applicator boom of the applicator,

FIG. 6 shows a schematic of the hydraulics for tilt control of the applicator, and

FIG. 7 shows a flow diagram according to which the control unit of the applicator operates.

### DETAILED DESCRIPTION

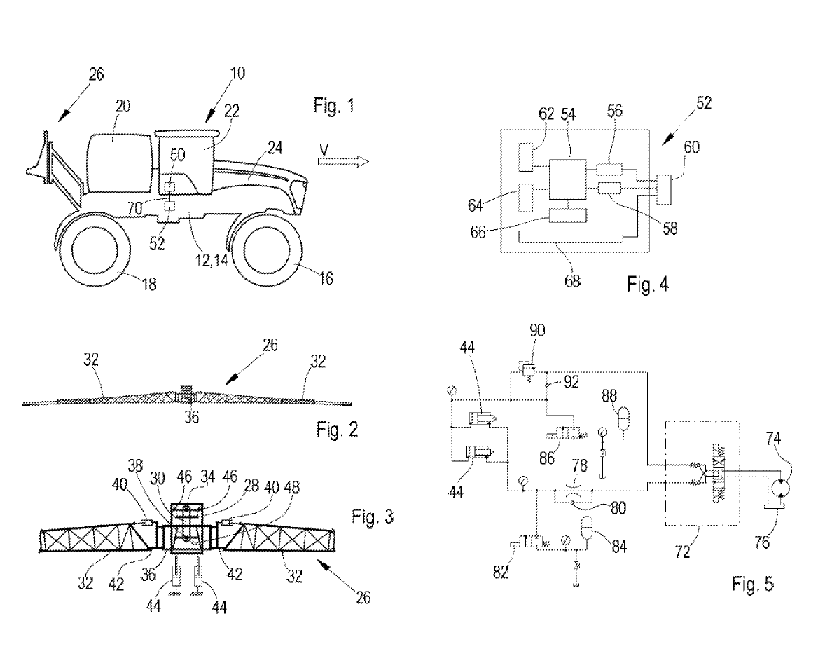

FIG. 1 shows an applicator 10 for application of liquid products in the form of a self-propelled vehicle, which may be designed as an apparatus that is towed or mounted on a tractor, as an alternative to the self-propelled embodiment. The applicator 10 includes a chassis 12 with a frame 14, which is supported on the ground on front wheels 16 and rear wheels 18. The wheels 16, 18 can be steerable and powered. A tank 20 for the products and a cabin 22 are supported on the frame 14 and a motor compartment 24 is situated in front of the cabin. The driving direction V in operation goes to the right in FIG. 1. At the rear on frame 14 of the applicator 10, a tilt and height adjustable applicator boom 26 is mounted, which is further shown from the rear in FIGS. 2 and 3.

An adjustment frame 28, which can be adjusted in height via linked hydraulic cylinders 44, is mounted on frame 14. A pendulum arm 30 is mounted on the adjustment frame 28 so that it can rotate about an axis 34 that extends in the forward direction V. A central segment 36 of the applicator boom 26 is mounted on the pendulum arm 30 so that it can rotate about an axis 38 that extends in the forward direction V. Two boom wings 32 of the applicator boom 26 are mounted to the left and right on the central segment 36 and can be adjusted with respect to the central segment 36 about axes 42 that extend in the forward direction V by means of hydraulic cylinders 40. The central segment 36 and the two boom wings 32 together form the applicator boom 26, which is provided with nozzles for application of the products from the tank 20.

The pendulum arm 30 can be rotated with respect to the adjustment frame 28 about the axis 34 that extends in the forward direction V by means of two linked hydraulic cylinders 46. Moreover, the central segment 36 of the applicator boom 26 can be rotated with respect to the pendulum arm 30 about the axis 38 that extends in the forward direction, likewise by means of a hydraulic cylinder 48.

A control unit 50 is connected to the hydraulic cylinders 40, 44, 46, 48 via appropriate valves and can undertake the following adjustments for control and regulation of the applicator boom:

Height control: The height of the central segment 36 of the applicator boom 26 is adjusted by adjusting the frame 28 up and down with respect to the frame 14 via a parallel kinematic mechanism by means of the hydraulically actuated cylinders 44.

Tilt of the pendulum arm 30: The pendulum arm 30 is adjusted rotationally with respect to the adjustment frame 20 via the two hydraulically actuated cylinders 46. The axis of rotation 34 in this case runs parallel to the lengthwise axis of the vehicle and the forward direction V.

Offset of the applicator boom 26 with respect to the pendulum arm 30: The central segment 36 of the applicator boom 26 is rotationally adjusted with respect to the pendulum arm 30. The axis of rotation 38 in this case runs parallel to the longitudinal axis of the vehicle and the forward direction V.

Adjustment of the applicator boom geometry: The two boom wings 32 of the applicator boom 26 are tilted with respect to the central segment 36 of the applicator boom 26 by means of the hydraulic cylinders 40. The axis of rotation 42 in this case runs parallel to the longitudinal axis of the vehicle and the forward direction V

Not mentioned up to now are actuators (not shown) which are needed for the purpose of moving the applicator boom 26 between the working position and the folded transport position. In some cases, the actuators that have already been mentioned can be employed for moving the boom 26 between working and transport positions. For example, the hydraulic cylinders 44 are used to lower the applicator boom 26 into the transport locking mechanism after it has been folded up.

Measurements are made of the accelerations (in three directions) and rates of rotation (likewise in three directions) of the chassis 12 by means of a measurement unit 52, which is mounted on frame 14 and is shown in FIG. 4. The measurement unit may include a processor 54, a bus interface 56, a digital input and output interface 58, a plug connector 60 which is connected via a conductor 70 to the control unit 50, an acceleration sensor 62, which is designed as a microelectromechanical element (MEMS), a gyroscope 64, which is designed as a microelectromechanical element (MEMS), and a power supply 68. The signals are sent to the control unit 50 and processed by it in order to identify the expected driving status of the applicator 10 via an evaluation of the vehicle dynamics. In addition, measurements of the suspension travel (for example, via cable potentiometers or by means of rotary potentiometers actuated by the boom or direct remote measurement methods such as based on ultrasound) or pressure measurements in the suspension system of the wheels 16, 18 can be employed to calculate the expected driving status of the applicator 10.

By means of the signals from the measurement unit 52, the control unit 50 can recognize different movement profiles of the chassis 12 which include, for example, travel on slopes, travel on hilly terrain, transitions between flat land and slope, excitations due to potholes, rocks, or unevenness in the field, and curved travel. The type of curve in a turning maneuver can be recognized by means of operating data from elements of the applicator (see DE 10 2014 202 181 A1).

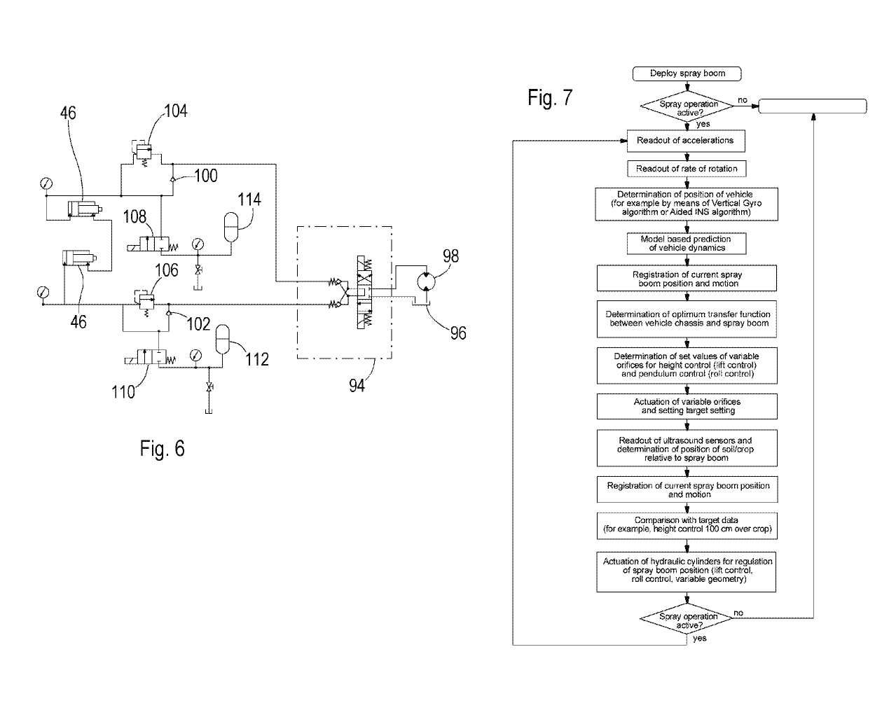

The control unit 50 enables an automatic adjustment of the dampening property of the applicator boom suspension to the relevant operating situation by utilizing the described hydraulic system that serves to adjust the applicator boom 26 along with the hydraulic cylinders 44 and 46 as an important dampening element. In this regard, and referring to FIGS. 5 and 6, the circuit of the hydraulic cylinders 44 for height control and the circuit of the hydraulic cylinders 46 for adjusting the tilt of the pendulum arm 30 are illustrated.

In the case of the height control according to FIG. 5, a switching valve 72 allows the hydraulic cylinders 44 for lifting or lowering to connect to a pump 74 or to a supply tank 76. To lift the frame 28, the piston chambers of the hydraulic cylinders 44 are filled via a check valve 92 and analogously the piston rod chambers of the hydraulic cylinders 44 are filled via a check valve 80 for lowering the frame 28. A pressure-controlled valve 90 is antiparallel-connected to the check valve 92 and an orifice 78 is parallel-connected to the check valve 80. Additional switching valves 82, 86 connect the piston chambers or the piston rod chambers of the parallel-connected hydraulic cylinders 44 to pressure tanks.

In the case of the tilt control according to FIG. 6, a switching valve 94 enables in each case one piston chamber of the hydraulic cylinders 46, the piston rod chambers of which are directly connected to each other via a line, to connect to a pump 98 or a supply tank 96 for adjustment of the tilt of the pendulum arm 30. To swivel the pendulum arm 30, the piston chambers of the hydraulic cylinders 46 are filled via check valves 100 or 102. In each case, pressure-controlled valves 104, 106 are antiparallel-connected to the check valves 100, 102. Additional switching valves 108, 110 connect the piston rod chambers of the hydraulic cylinders 46 to pressure tanks.

Accordingly, the control unit 50 can adjust on the one hand the height of the frame 28 and the tilt of the pendulum arm 30 in a substantially known way, based in particular on operator input via an operator interface (not shown) or sensors mounted on the applicator boom 26 (not shown) for registration of its height above the ground, and further connect the pressure tanks 84, 88, 112, 114 to the hydraulic cylinders 44, 46 via valves 82, 86, 108, and 110 in order to dampen the cylinders. Valves 82, 86, 108, and 110 can be designed as proportioning valves or can be controlled by pulse width modulation in order to be able to adjust the dampening in a continuously variable way. The current open cross section of the valves 82, 86, 108, and 110 and their geometry define the resistance to flow and thus the dampening characteristics of the hydraulic system. If the geometry of the valves 82, 86, 108, and 110 is designed as a throttle (i.e., the length of the taper is large by comparison with the cross section), the volume flow, in accordance with the flow principle, rises linearly with the pressure difference. If the geometry of the valves 82, 86, 108, and 110 is designed as an orifice (length of the taper small by comparison with the cross section), the pressure difference and volume flow behave nonlinearly. The dampening rate is also dependent on the hydraulic fluid temperature via the viscosity of the hydraulic oil. A temperature sensor in the hydraulic circuit can be used to compensate for this dependency. The pressure tanks 84, 88, 112, 114 act as spring elements via the preload generated by means of gas pressure. The gas pressure and thus the spring constant can usually not be actively adjusted or set during the operation of the machine.

The orifice 78 in FIG. 5 also causes a certain dampening of the hydraulic cylinders 44 and may have a variable orifice cross-section in order to adjust the dampening property by the control unit.

By means of the described identification of the movement profile, the hydraulic system can now be adjusted in terms of a semi-active dampening system to the usage profile of the applicator 10. Accordingly, the dampening of the hydraulic cylinders is actively regulated by the control unit on the basis of signals from the measurement unit 52 by means of the instantaneous tilt of the chassis 12, the instantaneous acceleration of the chassis 12, the instantaneous rate of rotation of the chassis 12, a predictive tilt of the chassis 12, a predictive acceleration of the chassis 12, and a predictive rate of rotation of the chassis 12.

The tilt, acceleration, and rate of rotation of the chassis 12 are predicted by the control unit 50 on the basis of variable physical parameters of the applicator 10. The parameters can be the setting of the variable track width of the applicator 10 (i.e., the lateral spacing of the wheels 16 and 18), the fill level of the tank 20, possibly the fill level of additional tanks (not shown), or data concerning the current geometry of the applicator boom 26 (for example, if one boom wing 32 is tilted with respect to the central segment 36 and the other boom wing 32 is tilted by means of a hydraulic cylinder 40). For this one can employ substantially known procedures, which calculate, by means of the measured values and the variable physical parameters, how the predicted values will look. Any mathematical model or an equation system derived therefrom, the parameters of which are matched to the current system of the applicator 10, as described, for example, in DE 10 2014 208 070 A1, can be used for the behavior of the applicator vehicle 10. The dampening of the hydraulic cylinders 44, 46 by the control unit 50 is determined in the manner described above with reference to FIGS. 5 and 6 by means of the predicted tilt, acceleration, and rate of rotation of the chassis 12 or the applicator 10. Thus, the dampening, and therefore the transfer function with which the hydraulics transmit possible variations of the applicator 10 to the applicator boom 26, is affected in a suitable way. For instance, the transfer function controlled by the control unit 50 on a side slope enables a good transfer of the movement of the chassis 12 of the applicator 10 to the applicator boom 26 (significant dampening), while in the case of potholes it will transmit the movement very little or not at all (no dampening).

The described procedure is further illustrated in the flow diagram of FIG. 7.

The dampening can be adaptively regulated on the basis of a position (for example, determined by means of a position determining system such as GPS) of the applicator 10 and stored data concerning the elevation profile of the field or the pneumatic pressure of a vehicle suspension of the applicator 10.

While embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. An agricultural applicator having a transport width and configured to move in a driving direction, comprising:
a chassis supported on a ground surface;
an applicator boom controllably movable with respect to the chassis about a pivot axis defined in the driving direction or suspended in a height-adjustable manner, the boom having a width measured transversely with respect to the driving direction and being greater than the transport width of the applicator;
an electronic control unit configured to receive a sensor value regarding a current driving status of the chassis; and
a dampening element for dampening the movement of the applicator boom, the dampening element being controllable by the electronic control unit based on the sensor value;
wherein, the electronic control unit is programmed to calculate an expected driving status of the applicator based on the sensor value and variable physical parameters of the applicator and to output a control signal to the dampening element based on an expected driving status of the applicator;
further wherein, the electronic control unit operably controls the dampening element to adjust dampening based upon a minimization of undesired movements of the applicator boom.

2. The applicator of claim 1, where the electronic control unit is programmed to take into account the effect of the current adjustable geometry of the applicator boom based on the expected driving status of the applicator when generating the control signal.

3. The applicator of claim 1, where the sensor value of the current driving status of the applicator or the expected driving status of the applicator is related to a lateral tilt of the chassis, a tilt of the chassis in a forward direction or vertical direction, a speed or acceleration of the chassis in at least one spatial direction, one orientation of the chassis about the vertical axis, lengthwise axis, or transverse axis, or a change of the orientation over time.

4. The applicator of claim 1, where the sensor value regarding the current driving status of the applicator is derived from measurement values of a vehicle suspension.

5. The applicator of claim 1, where the physical parameters of the applicator comprise its track width, total weight of the applicator, or fill level of a tank.

6. The applicator of claim 1, where the electronic control unit is programmed to receive data related to a topography of the ground surface to be traversed when calculating the expected driving status of the applicator.

7. The applicator of claim 1, where the electronic control unit is programmed to calculate the expected driving status by means of a mathematical model representing the physical behavior of the applicator or the applicator boom.

8. The applicator of claim 1, where the dampening element comprises a hydraulic cylinder.

9. The applicator of claim 8, where the hydraulic cylinder is simultaneously controllable by the control unit as an actuator for adjusting the applicator boom.

10. The applicator of claim 8, where the hydraulic cylinder is connected to a pneumatic pressure tank via a valve having an outlet opening, the outlet opening being operably controlled by the control unit.
